(19) United States
(12) Patent Application Publication
(10) Pub. No.: US 2021/0302971 A1
(43) Pub. Date: Sep. 30, 2021

(54) DEVICES, SYSTEMS AND METHODS FOR AUTONOMOUS ROBOT NAVIGATION AND SECURE PACKAGE DELIVERY

(71) Applicant: Savioke, Inc., San Jose, CA (US)

(72) Inventor: Steve Cousins, San Jose, CA (US)

(21) Appl. No.: 17/213,172

(22) Filed: Mar. 25, 2021

Related U.S. Application Data
(60) Provisional application No. 62/994,610, filed on Mar. 25, 2020.

(51) Int. Cl. G05D 1/02; G05D 1/00; B25J 9/16

(52) U.S. Cl. CPC G05D 1/0212; G05D 1/0231; G05D 1/0088; B25J 9/1697; G05D 1/0257; G05D 1/0094; G05D 1/0255

(57) ABSTRACT

A method can include, by operation of a control system for a robot, autonomously navigating to an elevator car location; by operation of at least one sensor on the robot, identifying an elevator call button; by operation of a movement system of the robot, positioning the robot proximate to the call button; extending a rising member vertically from the robot; rotating the robot to align a pushing member with the call button; and using sensor information from the robot, extending the pushing member from the rising member to contact and activate the call button. Corresponding devices and systems are also disclosed.

### CROSS-REFERENCE TO RELATED APPLICATIONS

This application claims the benefit of U.S. Provisional Patent Application Ser. No. 62/944,610 filed Mar. 25, 2020, the contents of which are incorporated by reference herein.

### TECHNICAL FIELD

The present disclosure relates generally to autonomous robots, and more particularly to robots able to navigate unmodified elevator systems, and related systems and methods.

### BRIEF DESCRIPTION OF THE DRAWINGS

FIGS. 1A to 1D are diagrams showing a robot for autonomously navigating elevator systems according to an embodiment.

FIGS. 2A to 2C are diagram showing an elevator button pushing operation according to an embodiment.

FIGS. 3A to 3C are diagram showing a robot positioning operation according to an embodiment.

FIG. 4 are diagrams showing a robot according to embodiments.

FIGS. 5A to 5L are a sequence of diagrams showing mobile robot-based systems for securely delivering packages according to embodiments.

FIGS. 6A to 6G are a sequence of diagrams showing mobile robot-based systems and methods for mobile vending according to embodiments.

FIG. 7A is a flow diagram of a method according to an embodiment.

FIG. 7B is a flow diagram of a method according to another embodiment.

FIGS. 8A and 8B are flow diagrams of methods according to further embodiments.

### DETAILED DESCRIPTION

Embodiments disclosed herein can include methods, robots, and systems for autonomously navigating elevator systems, including those that include push buttons.

Embodiments herein also disclose methods of securely delivering items with bins that are attachable and detachable from autonomously navigating robots.

Embodiments herein further disclose methods and systems of mobile vending with autonomously navigating robots.

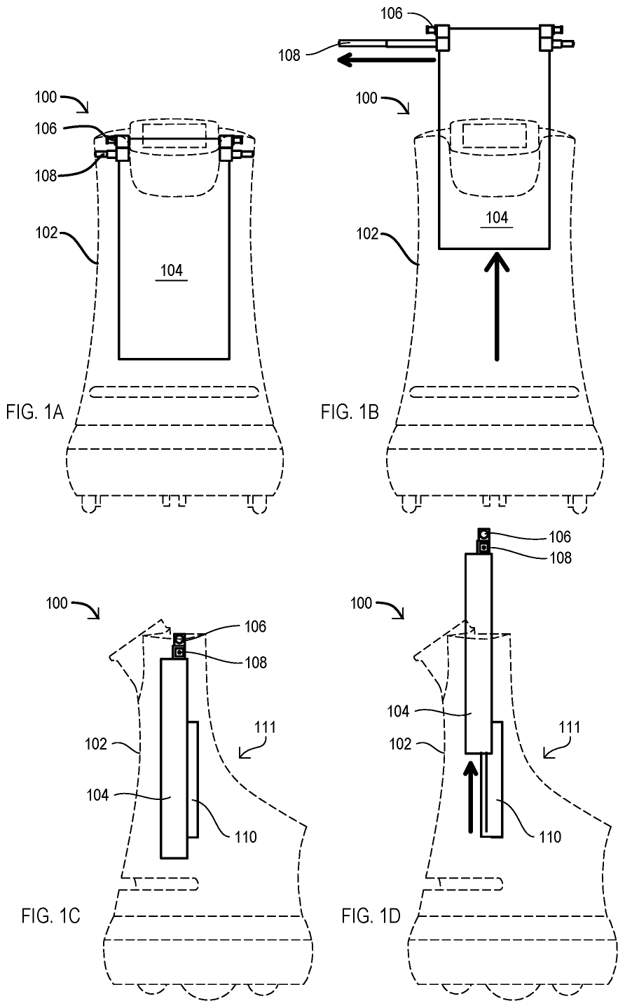

FIGS. 1A to 1D are diagrams showing a robot capable of activating a conventional elevator call button according to an embodiment. FIG. 1A shows robot 100 that includes an enclosure having a vertically extending member 104 (referred to herein as a “blade”) positioned within the enclosure. An enclosure 100 can extend more in a vertical direction than in a horizontal direction and can have a generally rounded shape in a horizontal plane. FIG. 1A shows a blade 104 in a retracted position. In the retracted position, all or a majority of the blade 104 can be within the enclosure. A robot 100 can have movement system that can enable linear and rotational movement.

A blade 104 can include one or more cameras (one shown as 106) and one or more pushers 108. A pusher 108 can extend in lateral direction, away from a center of the robot, to enable the activation of push buttons, including call buttons for elevators (both hall call buttons to call an elevator car, as well as call buttons within an elevator car). A camera 106 can have a field of view that includes the pusher 108 in an extended position. In the embodiment shown, a blade 104 can include an opposing camera and pusher. In some embodiments, a blade 104 can have a relatively blade-like shape, that when viewed in a horizontal direction, can be narrower in one direction (i.e., in the direction perpendicular to the view of FIG. 1A) than the other (i.e., laterally in the view of FIG. 1A). A blade 104 can have any suitable shape, including a curved shape.

FIG. 1B shows robot 100 in a pusher activation operation. Blade 104 can extend above a top of the robot 100 in the vertical direction. Further, a pusher 108 can extend in a direction away from the robot 100. Camera 106 can have a field of view that includes extended pusher 108. Such an arrangement can enable a robot 100 to easily align the pusher 108 with an intended target (e.g., an elevator call button).

FIG. 1C shows the robot 100 of FIG. 1A in a side view. FIG. 1C shows a driver 110 which can vertically drive the blade 104 in an upward direction and then retract it back down so that all or a portion of the blade 104 is included in the enclosure 103. A driver 110 can take any suitable form and can vary according to robot construction and limitations. FIG. 1C also shows how a robot 100 can include a bin receiving section 111. As will be described at a later point herein, a bin receiving section 111 can receive a bin (not shown) that can include items for delivery. A bin receiving section 111 can receive a bin that can mechanically attach to the robot 100.

FIG. 1D shows the robot 100 of FIG. 1B in a side view. Driver 100 has moved blade 104 in the vertical direction.

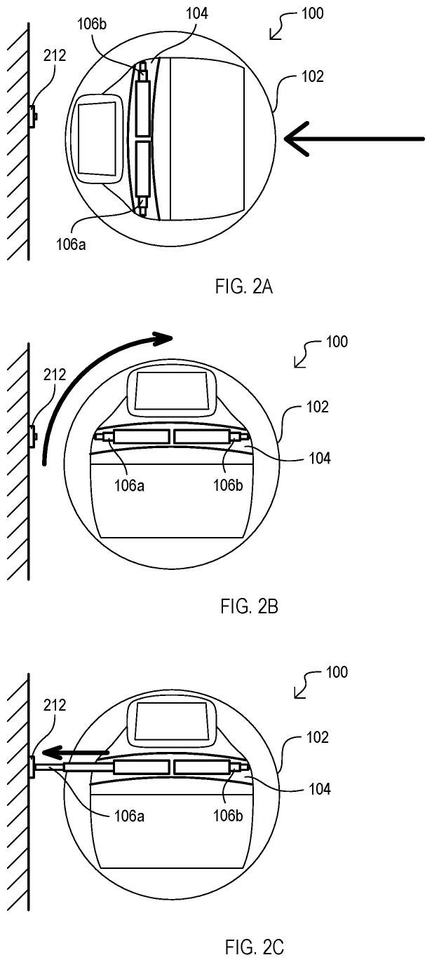

FIGS. 2A to 2C are top view diagrams of a robot button activation operation according to an embodiment. FIGS. 2A to 2C show a robot 100 and targeted button 212. A robot 100 can be one implementation of that shown in FIGS. 1A to 1D, and can include a vertically extending blade 104 with pushers 106a/b. A blade 104 can also include a camera (not shown) corresponding to each pusher.

In FIG. 2A, robot 100 can move to a position proximate the button 212. At this time a robot 100 blade 104 can be retracted. Such a position can be considered a button pushing position.

In FIG. 2B, robot 100 can align a pusher 106a with button 212. Such an action can include a robot 100 moving rotationally (and linearly if needed) until the pusher 106a is aligned with button 212. In some embodiments, this can include using data from a camera having a field of view that includes the pusher 106a direction. In other embodiments, a robot 100 can have stored button pushing information to enable automatic button pushing operation. Such stored data can have been derived by the robot 100 or programmed into the robot 100.

In FIG. 2C, robot 100 can extend pusher 106a to contact and activate the button 212.

An operation shown in FIGS. 2A to 2C can be executed by a robot to call an elevator, as well as select a destination floor once inside an elevator.

In some embodiments, such an action can include a robot utilizing its movement capabilities with a button pushing mechanism having only two degrees of freedom: a vertical extension of blade 104 and a horizontal extension of pusher 108a or 108b. This is in very sharp contrast to conventional approaches that require complex arm or extensions that swivel, etc.

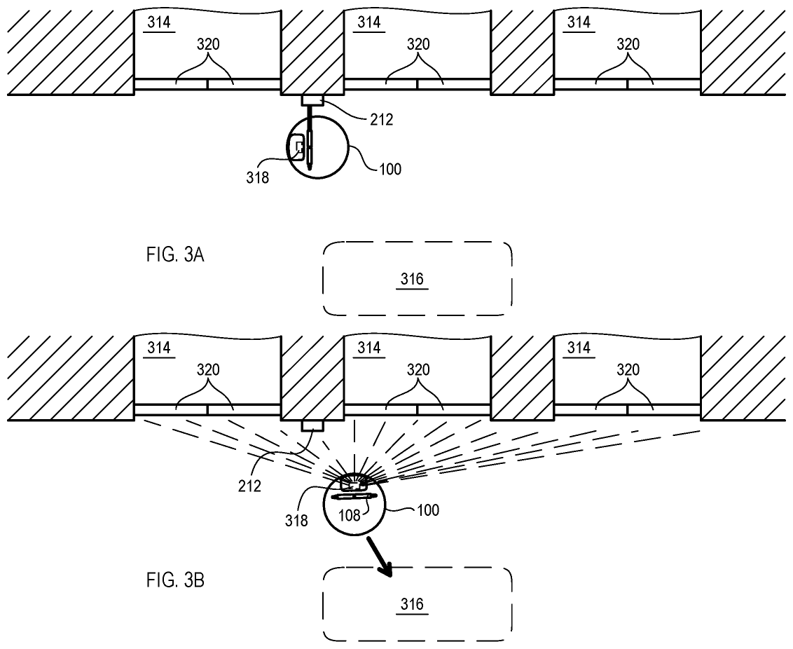

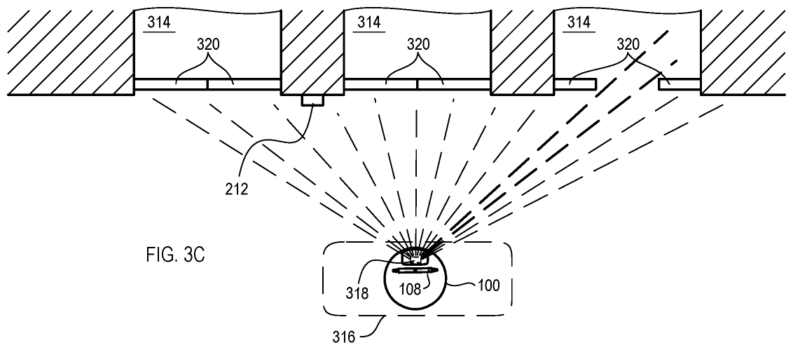

FIGS. 3A to 3C are diagrams showing a robot positioning operation according to an embodiment. FIGS. 3A to 3C show a robot 100 in an operating environment including multiple elevator cars 314, each with doors 320. In some embodiments, a robot 100 can be one implementation of that shown in FIGS. 1A to 1D. A robot 100 can include one or more detection systems 318 that can determine when doors 320 are opened or closed. In some embodiments, a detection system 318 can include a beam detection system that can emits beams and processes return signals from such beams. As but one of many possible examples, a detection system 318 can be LIDAR type system.

A robot 100 can determine, or can have previously determined, a monitoring region for the elevator area. From a monitoring region 316, a robot 100 can monitor all, or a predetermined set of, elevator cars with its detection system(s) 318. A monitoring position 316 can be considered an elevator watch pose for the robot 100. In some embodiments, monitoring position 316 is sufficiently distant from elevator 314 to not prevent pedestrians from entering and/or exiting the elevators.

FIG. 3A shows robot 100 activating a call button 212. Such an action can include any of those described herein, including a vertical blade/horizontal pusher combination.

FIG. 3B shows actions of robot 100 following the activation of the call button 212. A robot 100 can determine button 212 has been activated (e.g., a camera sense a change in the button). Following such a determination, robot 100 can begin moving toward monitor region 316. As it moves to monitor region 316, a robot 100 can direct all, or a portion of its detection system 318 capabilities toward all or a portion of the elevator cars 314. In some embodiments, a robot 100 can prioritize the sensing of opening doors to those elevator cars in closest proximity.

If robot 100 detects the opening of a door 320 before it reaches the monitoring region 316, the robot 100 can attempt to navigate toward the corresponding elevator car.

FIG. 3C shows robot 100 in monitor region 316. The robot 100 has reached the monitoring region 316 after activating the button, without having sensed the arrival of any elevator car (e.g., the opening of a car door). A robot 100 can monitor all, or the predetermined number, of elevator doors 320 with monitoring system 318.

Upon detecting the opening of a door 320, the robot 100 can attempt to navigate toward the corresponding elevator car. A robot 100 can detect the opening of a door 320 with any suitable manner, including the beam emitting systems described herein. In addition or alternatively, a robot 100 can detect audio cues, such as an elevator car arrival chime, or a robot 100 can receive a wireless signal from an elevator car 212 or elevator control system indicating the arrival of the elevator car.

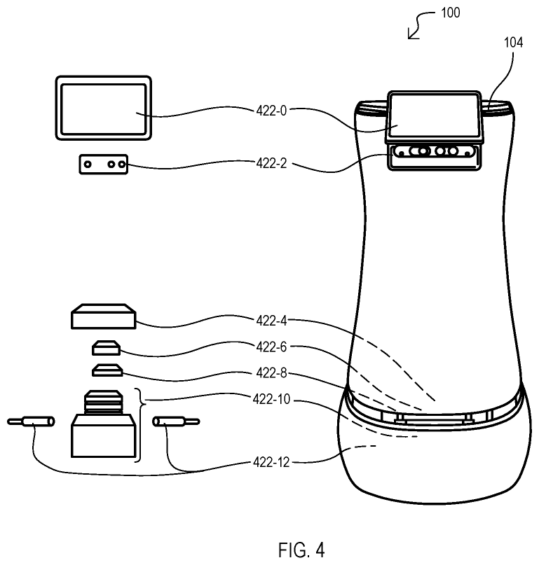

FIG. 4 shows a robot 100 according to embodiments, as well as selected components of the robot 100 in an exploded view. In some embodiments, robot 100 can be one very particular implementation of robot 100 shown in FIGS. 1A to 1D.

A robot 100 can have a generally cylindrical shape. A touch display interface 422-0 can be included for user input and/or messaging, and can be mounted at the top of the robot 100 at an angle convenient for viewing and user input. In addition to providing a visible display and/or touch input, a touch interface 422-0 can be used for speech input/output, as well as programming the robot 100 for tasks.

A robot 100 can include a suite of navigation sensors 422-2 to enable robot 100 to autonomously navigate between different locations. Such a sensor suite 422-2 can include, but is not limited to: a forward-looking depth sensor, a downward looking depth sensor, a depth sense video camera, or various beam type sensors.

A robot 100 can be controlled by one or more processors executing stored instructions that can be responsive to sensor inputs and/or transmitted inputs. In a particular embodiment, an x86 or similar central processing unit 422-4 can be used in conjunction with one or more microcontrollers 422-6 and motor controllers 422-8 for local control of movement of the robot 100. Processing unit 422-4 can be programmed to execute the robot operations described herein, and equivalents.

In the robot 100 of FIG. 1, differential drive motors 422-12 powered by batteries 422-10 can provide movement by driving wheels (not shown) that support the robot 100. In particular embodiments, batteries 422-10 can be lithium ion or some other battery type, rechargeable battery systems being preferred. A drive mechanism includes separate drive motors 422-12 each attached to its own wheel, in a differential drive configuration. A drive mechanism can include additional wheels (not shown). In some embodiments, a drive mechanism can enable robot 100 to move both linearly and to rotate in place.

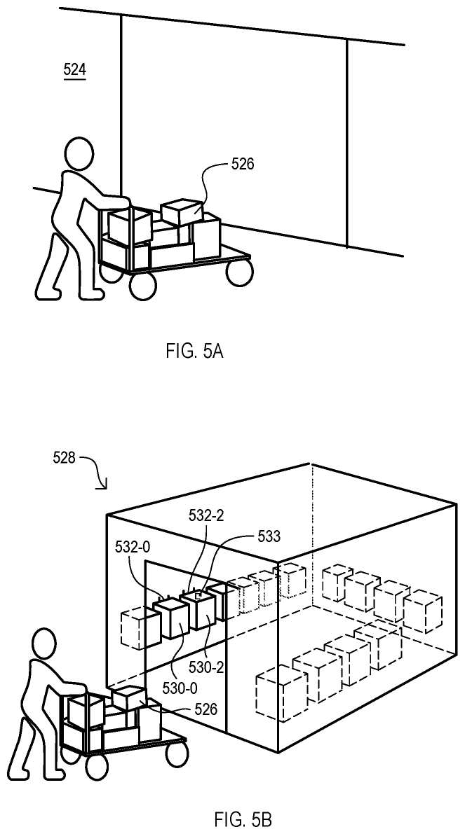

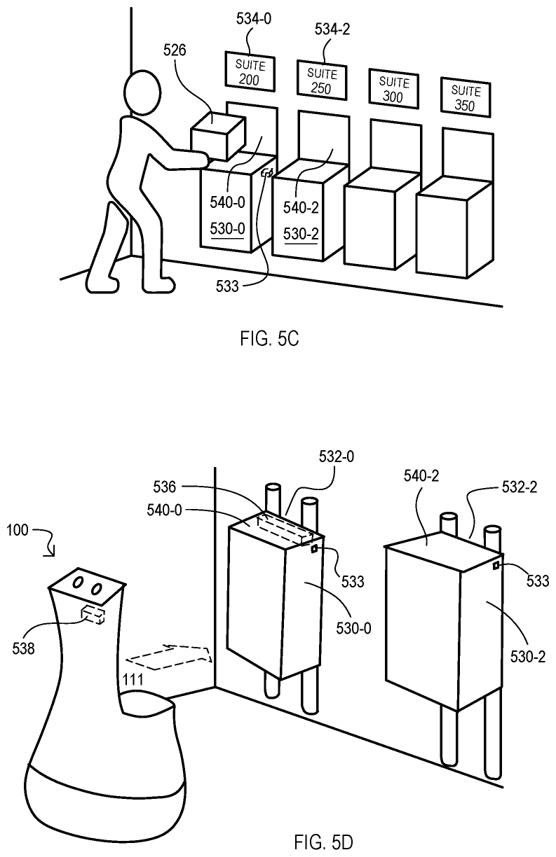

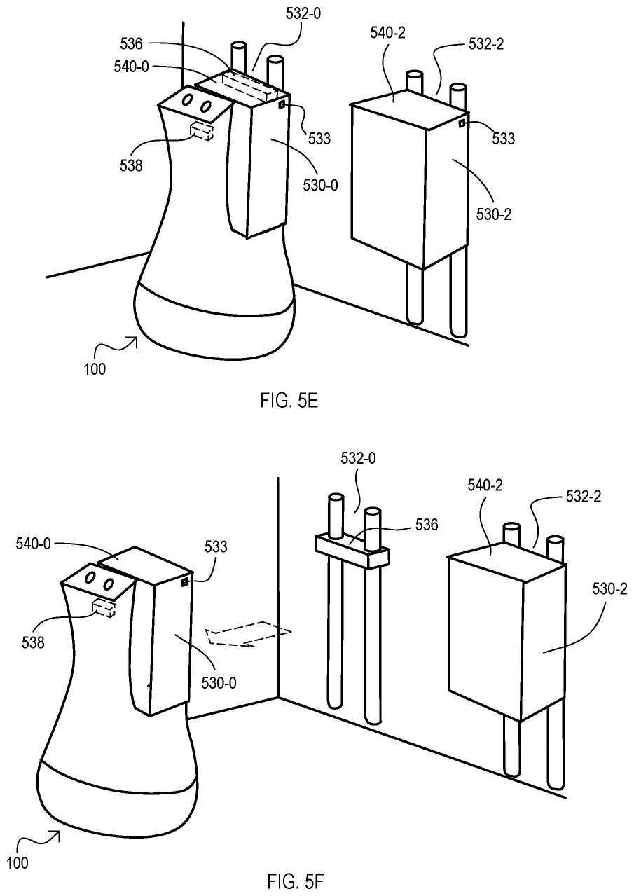

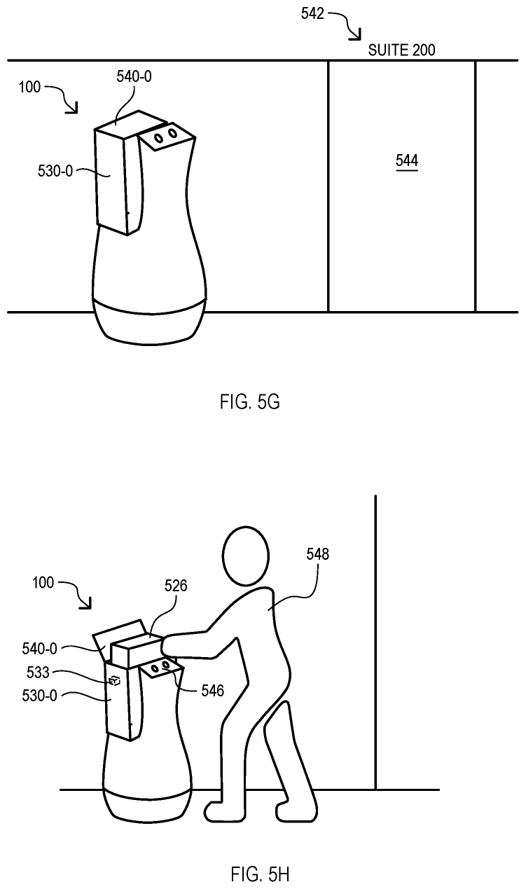

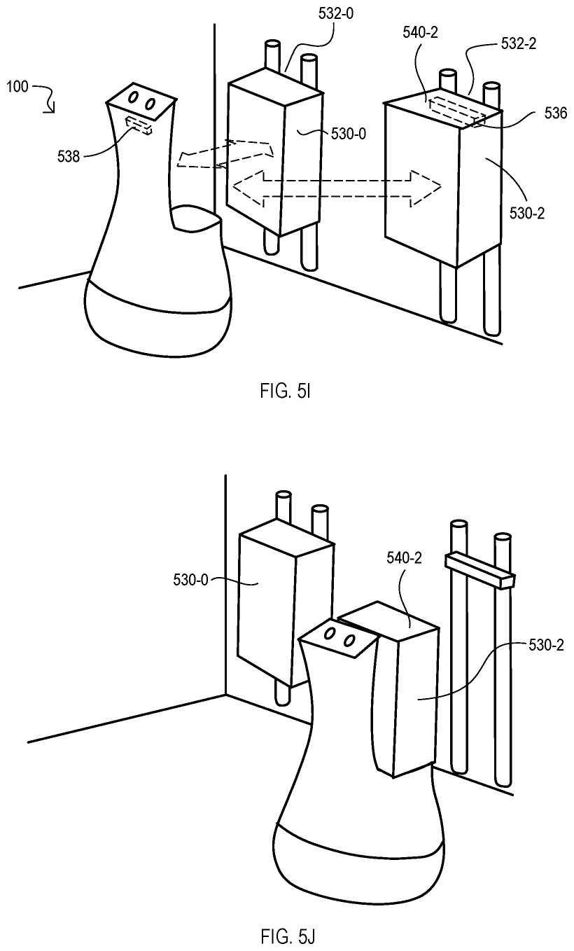

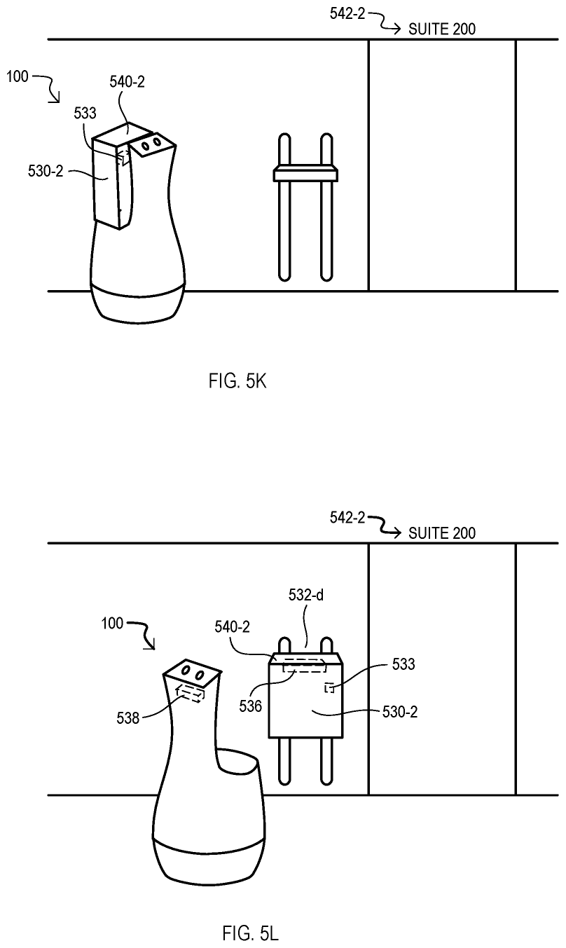

FIGS. 5A to 5L are a sequence of drawings shown mobile robot-based systems and methods for securely delivering packages.

Referring to FIG. 5A, items (one shown as 526) can arrive at an environment 524 for delivery at any of a number of different locations of the environment. An item 526 can be any suitable item, and in some embodiments can include a package for delivery by a postal or private carrier. An environment 524 can be any suitable site, including but not limited to a building having multiple floors accessible via an elevator system. However, an environment 524 can include outside locations, such as neighborhoods, for example.

FIG. 5B shows a bins location 528. A bins location 528 can include a number of bins (two shown as 530-0/2) that can be concentrated at a single location. Bins 530-0/2 can be attached to walls at a wall mount interface (two shown as 532-0/2). In some embodiments, each bin 530-0/2 can correspond to a location of the larger environment. Items for delivery (e.g., 526) can be transported into bins location 528 for subsequent delivery to a particular location of the environment.

Referring still to FIG. 5B, bins 530-0/2 can include a communication device (one shown as 533). A communication device 533 can communicate with a system and/or robot in a wireless manner. Communication device 533 can communicate any of various state information for the bin 530-0/2. State information can include, but is not limited to: a bin location, bin lid status (e.g., opened, closed, locked, unlocked), temperature, or inventory. A communication device 533 can communicate according to any suitable protocol, and in particular embodiments, can communicate according to a low data rate transmission protocol, such as IoT cellular. In some embodiments, a bin 530-0/2 can have an optimal size for delivered packages. In very particular embodiments, a bin 530-0/2 can accommodate a package size of about 18″×12″×10″.

FIG. 5C shows a loading operation at a bins location. Bins 530-0/2 can each include a lockable lid (or door) 540-0/2. FIG. 5C shows bins with lids 540-0/2 in an open position. In the embodiment shown, each bin 530-0/2 has a bin location id 534-0/2, which can indicate a location to which a bin 530-0/2 can be delivered by a robot (not shown). Items 526 can be loaded into bins. FIG. 5C shows item 526 being loaded into bin 530-0. In some embodiments, when bin 530-0 is loaded with item 526, a communication device 533 of bin 530-0 can transmit a state to a larger system. Such a state can include but is not limited to any of: the bin is loaded, the bin has been closed, the bin has been locked, an identification of the item contained by the bin, the loaded capacity of the bin, or the temperature inside the bin.

FIG. 5D shows a robot bin loading operation according to an embodiment. A robot 100 can autonomously navigate to a bins location. A robot 100 can take the form of any of those shown herein, or equivalents. A robot 100 can include a bin receiving section 111 (where a bin can attach). A robot 100 can also include a robot-bin interface 538 at which a bin can attach to robot 100. A robot-bin interface 538 can be located at any suitable location, and the position shown in FIG. 5D should not be construed as limiting. A robot-bin interface 538 can be any suitable interface for mechanically securing a bin 530-0/2 to a robot 100 at bin location 111. In some embodiments, a robot-bin interface 538 can be lockable by operation of the robot 100. In other embodiments, a robot-bin interface 538 can be controlled by a person external to the robot 100.

Referring still to FIG. 5D, bins 530-0/2 can be attached to a wall mount 532-0/2 with a wall mount interface (one shown as 536). A wall mount interface 536 can secure a bin 530-0/2 to a wall mount 532-0/2. In some embodiments, a wall mount interface 536 can be lockable by any of: the bin 530-0, a robot 100, or a user. A robot 100 can align its bin location with a desired bin 530-0, and then navigate to the bin. Bins 530-0/2 can include lockable lids (or doors) 540-0/2. Lockable lids 540-0/2 can be placed into a locked state, after which the lids 540-0/2 can be opened by an appropriate authentication procedure.

FIG. 5E shows a robot 100 attaching to bin 530-0. A robot 100 can maneuver to bin 530-0 to enable the bin 530-0 to be attached to the robot 100 at robot-bin interface 538.

FIG. 5F shows a robot 100 navigating out of a bins location to a delivery location corresponding to bin 530-0. In some embodiments, a bin 530-0 can be released from a wall mount interface 536. Such a releasing operation can be performed as a result of robot 100 attaching to the bin 530-0. A releasing operation can be performed by any including, but not limited to: the robot 100, the bin 530-0, the wall mount interface 536, or a user. Releasing a bin 530-0/2 may or may not include unlocking a bin 530-0/2, if the bin includes a lockable lid/door 540-0/2.

Once a bin 530-0 is attached to robot 100, robot 100 can start navigating to a delivery location corresponding to the bin 530-0. A robot 100 can determine the delivery location in any suitable manner, including but not limited to: having the location programmed into the robot 100, determine the delivery location from the bin and/or bin position in the bin's location. In some embodiments, a communication system 530 can transmit a state of bin 530-0 once it has been removed from wall mount 532-0.

FIG. 5G shows a robot 100 navigating to a delivery location 542 according to an embodiment. Robot 100 can transport bin 530-0 having a lid 540-0 that can be locked to secure a delivery item therein. In the embodiment shown, a delivery location 542 can be a suite in a building having a door 544. In some embodiments, robot 100 can contact occupants of the location 542 to inform them that the package has arrived. Such contact can occur in any suitable manner, including but not limited to electronic communication (e.g., email, phone, text, etc.) as well as physical (e.g., ring a doorbell, knock on a door, push a central intercom button to notify the room).

FIG. 5H shows a location authentication operation according to an embodiment. A user 548 can execute an authentication operation 546 that results in lid/door 540-0 being unlocked and/or opened. A delivery item 526 can then be removed from the bin 530-0. An authentication operation can occur with the robot 100, or alternatively, with the bin 530-0. Authentication can take any suitable form, including but not limited to: a physical identification (e.g., RFID badge), electronic device (e.g., smartphone), a PIN code, or biometrics. In some embodiments, authentication can include a two-factor process. An authentication process can also occur via robot interface 546. In some embodiments, when an item 526 is removed from a bin 530-0, a communication device 533 can transmit a state to a larger system. Such a state can include but is not limited to any of: the bin has been unloaded, the bin has been opened, the bin has been unlocked, an identification of the item 526 removed, data related to the authentication process.

FIG. 5I shows a robot exchanging one bin for another bin according to an embodiment. A robot 100 can return bin 530-0 to a designated wall mount at a bins location. Such an action can include a robot 530-0, which is carrying bin 530-0, moving to connect bin 530-0 to wall mount 532-0. In some embodiments, when a bin 530-0 contacts a wall mount 530-0 it can automatically connect to the wall mount 530-0. Further, the bin 530-0 and/or the robot 100 can lock the bin to its wall mount 530-0. FIG. 5I shows robot 100 after returning bin 530-0 to wall mount 532-2. Following such an action, robot 100 can move and connect to another bin 530-2. Such an action can include operations like those described in FIGS. 5D and 5E.

FIG. 5J shows robot 100 navigating to a delivery location for its newly attached bin 530-2.

FIG. 5K shows a robot 100 navigating to a second delivery location 542-2 corresponding to bin 530-2. A second delivery location 542-2 can include a bin mounting structure 532-0 to enable the entire bin to be dropped off. In some embodiments, robot 100 can attempt to contact occupants of second delivery location 542-2, as described herein or equivalents.

FIG. 5L shows a robot 100 delivering a bin 530-2 to a destination wall mount 532-d. A destination wall mount 530-d can take the form of those described for a bins location. However, in other embodiments a destination wall mount 530-d can be different from those of a bins location. As but one example, at a bins location, bins may not lock to wall mounts, while a bin 530-2 can lock to the destination wall mount 532-d. A robot 100 can move to connect bin 530-2 to destination wall mount 532-d at a wall mount interface 536. A robot 100 can then disconnect from the bin at its robot-bin interface 538 leaving the bin 530-2 securely attached to the destination wall mount 532-d. In some embodiments, a robot 100 can connect a bin 530-2 to a destination wall mount 532-d upon failing to contact occupants at the second destination 542-2. In some embodiments, when a bin 530-2 is connected to a destination wall mount 532-d, a communication device 533 can transmit a state to a larger system. Such a state can include that the bin 530-2 has been delivered to the second destination. Further, if an item is removed from bin 530-2 (while it is attached to the destination wall mount), a communication device 533 can transmit such updated state information to a larger system. Such a state can include but is not limited to any of: the bin has been unloaded, the bin has been opened, the bin has been unlocked, an identification of the item removed, data related to an authentication process used to unlock the bin 530-2.

Systems and methods described with reference to FIGS. 5A to 5L can enable autonomous delivery of items in which a chain of custody can be recorded and/or ensured. An item can be locked within a bin, delivered to a secure location, and only unlocked with appropriate authorization.

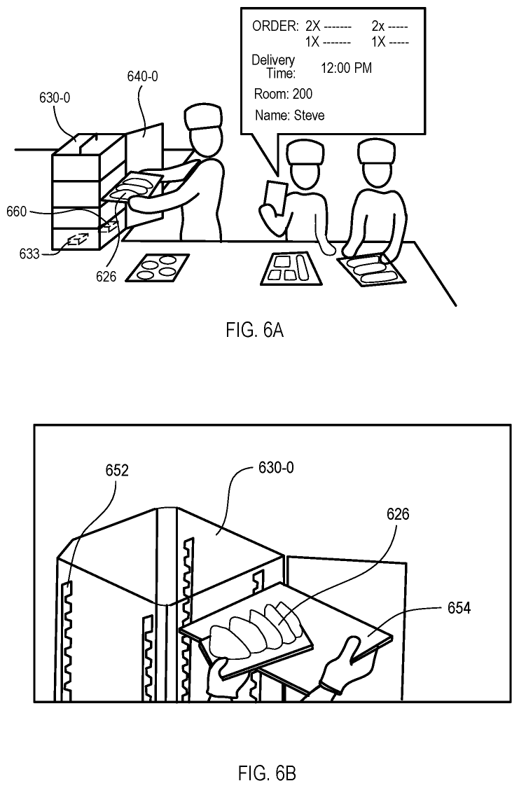

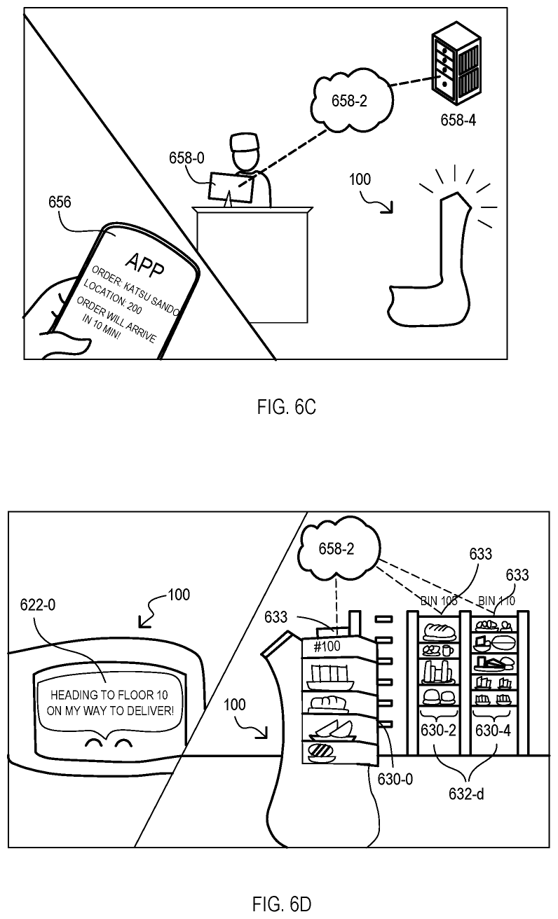

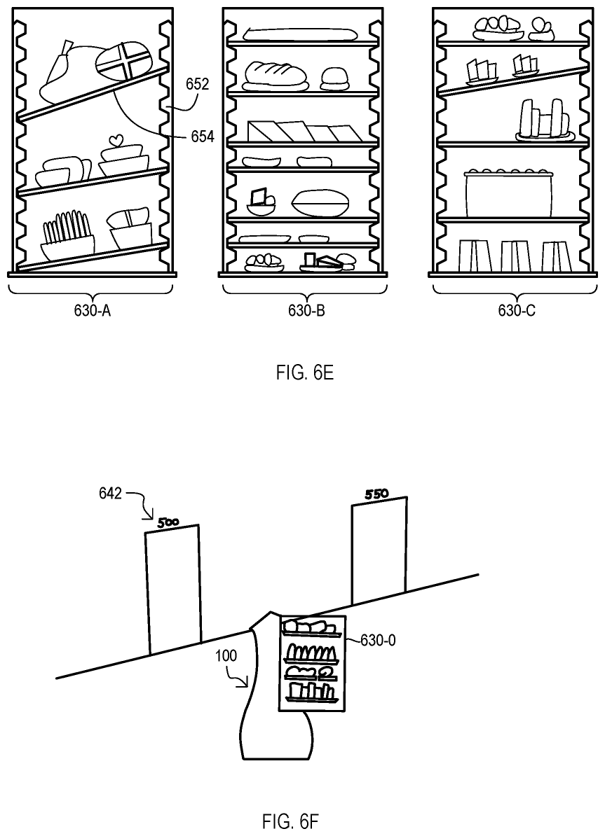

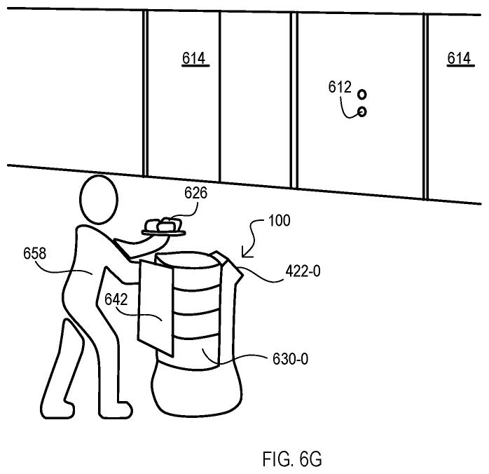

FIGS. 6A to 6G are a sequence of drawings shown mobile robot-based systems and methods for mobile vending.

FIG. 6A shows the loading of a bin 630-0 with vending items 626. A bin 630-0 can include a lid or door 640-0. Further, a bin 630-0 can include one or more sides that are transparent (including a lid/door) to enable items to be visible when inside the bin 630-0. In the embodiment shown, items 626 can be food items for purchase by people of an environment. A bin 630-0 can include more than one compartment, or receive partitions (e.g., trays) that can essentially divide the bin into compartments.

Referring still to FIG. 6A, in some embodiments, a bin 630-0 can include a communication system 633 to enable state data for the bin 630-0 to be transmitted to a larger system. State data can include any of those described herein, or equivalents. In some embodiments, a bin 630-0 can include a temperature control system 660. A temperature control system 660 can maintain a temperature within a bin 630-0 with a cooling and/or heating system. In some embodiments, a bin 630-0 can include its own power source (e.g., battery) to power a temperature control system 633. In other embodiments, the temperature control system 633 of a bin can be powered all, or in part, by a robot when the bin 630-0 is attached to a robot.

FIG. 6B shows a bin 630-0 according to one embodiment. A bin 630-0 can be formed of a transparent material, such as an acrylic, as but one of many possible examples. A bin 630-0 can receive trays (one shown as 654) onto which items 626 can be placed. In some embodiments, a tray 626 can include one or more sensors to detect when items are taken. As but one of many possible examples, tray sensors can be based on proximity or pressure. A bin 630-0 can also include tray mounts 652. In some embodiments, tray mounts 652 can be open groove type mounts that can enable trays to be situated horizontally (by inserting opposing edges of the tray into grooves at a same vertical level) or at an angle (by inserting opposing edges of the tray into grooves at different vertical levels).

FIG. 6C shows an inventory system according to an embodiment. Vending items in particular bins can be entered into a system at an interface device 658-0. In the embodiment shown, an interface device 658-0 can be a computer terminal, or the like, which can be in communication with a server 658-4 via a network 658-2, which can include the internet. Server 658-4 can include an inventory tracking system which can track any of: which items are in which bins, a location of each bin, and when items are removed from bins. Server 658-4 can also include a purchasing system to enable users to purchase items located in a bin. In some embodiments, inventory data can be updated when a bin connects to an autonomous delivery robot 100. Location/delivery data for the autonomous robot can then be associated with the vending items.

Referring still to FIG. 6C, a system can also include one or more applications 656 executable on user electronic devices to enable ordering of items. An application 656 can enable any of various functions for ordering items, including but not limited to: ordering and paying for items, searching for items by location (e.g., closest bins), being updated on order information (when bin has been delivered to a location).

FIG. 6D shows a robot 100 delivering bins vending destination locations. On the left, FIG. 6D shows a robot interface 622-0 which can display a status of robot 100. In some embodiments, while a robot 100 is on its way to a delivery location, the robot interface 622-0 can display its current task. Such a display can ensure that users the robot 100 might encounter on the way understand the robot 100 cannot currently handle purchases. However, as will be shown at a later point herein, a robot 100 can enter a vending mode in which items can be taken and/or purchased from a bin.

Referring still to FIG. 6D, a robot 100 can deliver its bin 630-0 to a destination location. FIG. 6D shows other bins 630-2, 630-4 already at their destination locations 632-d. In some embodiments, destination locations 632-d can include any of: power for controlling a temperature of bins 630-2/4, lighting to enhance the display of items in the bin (e.g., back lighting), a payment system for purchasing items contained in bins 630-2/4. Bins 630-0/2/4 can include communication systems 633 which can be in communication with a larger inventory/purchase system via a wireless network 658-2.

FIG. 6E shows bins 630-A/B/C having trays (one shown as 654) at various configurations. Bins 630-A/B/C can take the form of any of those shown herein, or equivalents. Bin 630-A shows how trays 654 can be angled to provide an advantageous view of items contained within a bin. Bin 630-B shows how trays can be organized to maximum storage space. Bin 630-C shows how bin storage can be flexible, enabling some trays to be angled, while others are not.

FIG. 6F shows how a robot 100 can deliver a vending type bin 630-0 to a destination location 642. Such an action can include a robot 100 attempting to contact occupants 642 at a destination location to retrieve ordered items and/or select items from bin 630-0. Items in bin 630-0 may or may not be items ordered by occupants. Items in bin 630-0 may have been previously paid for or can be paid for on the spot via robot 100 or an interface on bin 630-0.

FIG. 6G shows a robot 100 executing portable vending operations. A robot 100, via an interface 422-0 for example, can indicate items carried in its bin 630-0 are available. Such an indication can be visual and/or audio, as but two examples. A robot 100 can be stationary, or stop when approached by a user, or stop on any other suitable condition. A user 658 can access a bin 630-0 to acquire one or more items 626. In some embodiments, a lid/door 642 of bin 630-0 can be unlocked by some interaction with user 658 to enable access to item(s) 626. Such an interaction can include payment and/or authentication via the robot 100 or an interface on the bin 630-0.

Referring still to FIG. 6G, a robot 100 can navigate an elevator system with a blade and pusher combination, or an equivalent, to operate call buttons 612 as described herein. Further, a robot 100 can use a beam system to monitor doors 614 and detect when doors are opened as described herein.

While the embodiments above have described various methods in conjunction with devices and systems, additional methods will now be described. These methods, along with previous methods, can be executable by processing circuits of a robot.

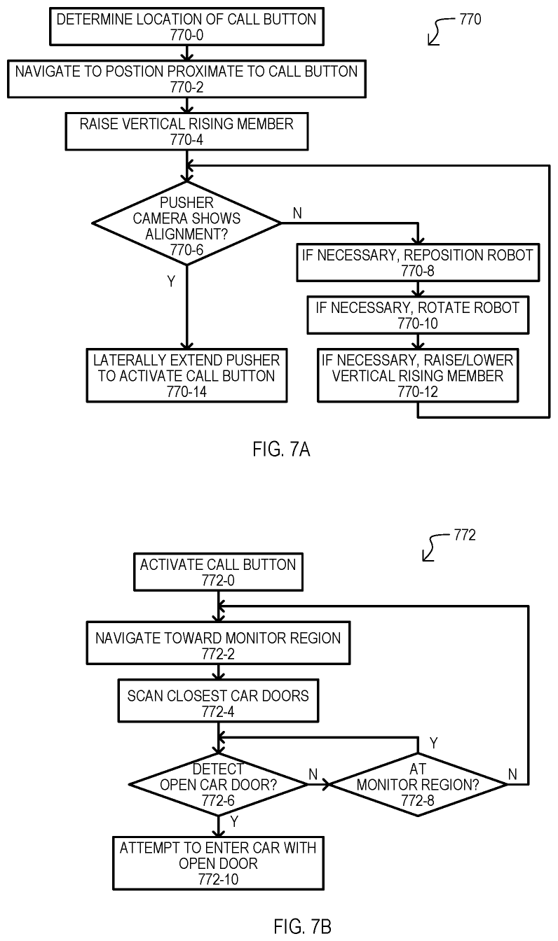

FIG. 7A is a flow diagram of a method 770 for activating a call button with a robot according to an embodiment. A method 770 can include a robot determining a location of a call button 770-0. Such an action can include a robot accessing map information while navigating between floors. In addition, such an action can include a robot using sensors (e.g., cameras) to locate call buttons or intercoms when in range. A robot can navigate to a position proximate the call button 770-2. Such an action can include a robot navigating to within a predetermined maximum distance from a call button. Such a maximum distance can be a maximum lateral distance reachable by a pusher on the robot. In some embodiments, such an action can include a robot maneuvering into a predetermined pose (e.g., generally aligning a pusher with the call button). In some embodiments, a robot can account for lighting conditions by adjusting sensors accordingly. In addition or alternatively, a robot can provide its own lighting.

A method 770 can include a robot raising a vertical rising member 770-4. Such an action can include a robot extending a blade-like member from within an enclosure. In some embodiments, a blade-like member can have one direction of travel (i.e., vertically). A robot can determine if a pusher camera shows the pusher is aligned with the call button 770-6. Such an action can include using a camera having a field of view that includes the path a pusher follows when it extends from the robot. If the pusher is not aligned with the call button (N from 770-6), a robot can, if necessary, reposition itself 770-8 (i.e., move in a linear manner), rotate 770-10 or raise or lower the vertical rising member 770-12

Once the pusher is determined to be aligned with the call button (Y from 770-6), the pusher can be extended to activate the call button 770-14. In some embodiments, a pusher can have one direction of travel (i.e., horizontally).

FIG. 7B is a flow diagram of a method 772 of monitoring elevator car doors after activating a call button.

A method 772 can include activating a call button 772-0. Such an action can include any of the methods described herein, or equivalents. Once call button has been activated, a robot can navigate toward a monitor region 772-2. A monitor region can take the form of those described herein or equivalents. In some embodiments, a monitor region can enable a robot to monitor all elevator car doors at a location with a beam sensing system. Alternatively, a monitor region can enable the robot to monitor a predetermined number of elevator car doors (e.g., all elevator car doors on one side of hall or a majority of elevator car doors).

As the robot moves toward the monitor region, the robot can scan the closest car doors 772-4. Such an action can include a robot scanning the closest number of car doors possible with a beam sensing system. If the robot does not detect the opening of a door (N from 772-6), the robot can determine if it has arrived at the monitor location 772-8. If the robot has not arrived at the monitor location 772-8 it can return to 772-2. That is, the robot can continue to move toward the monitor region while scanning for opening doors.

If the robot detects the opening of a door (Y from 772-6) without having reached the monitor region, the robot can cease navigating toward the monitoring region and instead attempt to board the elevator car with the opening/open door 772-10.

Once the robot reaches the monitor region (Y from 772-8), the robot can monitor elevator car doors. If the robot detects the opening of a door (Y from 772-6) t the robot can attempt to board the elevator car with the opening/open door 772-10.

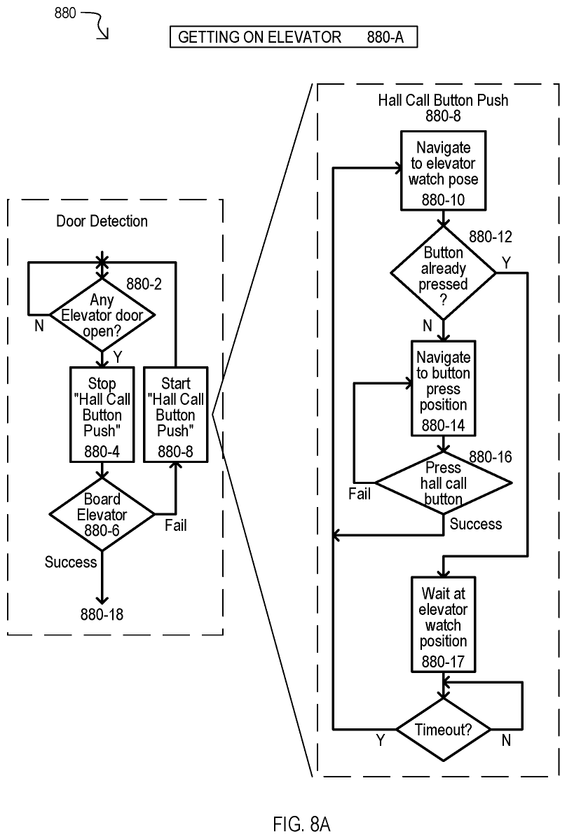

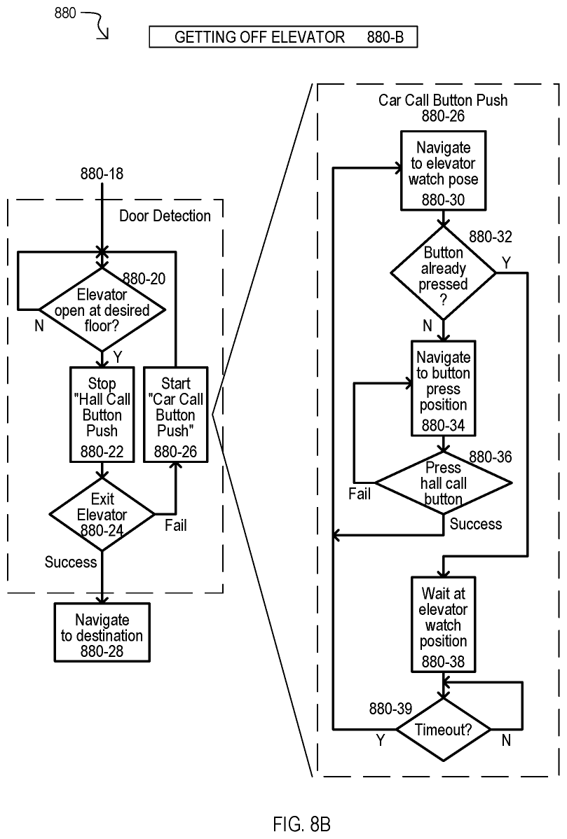

FIGS. 8A and 8B are flow diagrams showing a method 880 of navigating an elevator system according to an embodiment.

FIG. 8A shows a first portion 880-A of a method 880 that includes a robot getting on an elevator car. Getting on the elevator 880-A can include a robot determining if any elevator car doors are open 880-2. Such an action can include a robot using any suitable type of sensor(s), including but not limited to beam emitting sensors. Action 880-2 can also occur as the robot is approaching an elevator location. If an elevator door is not open (No from 880-2), a robot can continue to check a status of elevator. In some embodiments, this can include the robot continuing to navigate toward a hall call button.

If an elevator door is open (Yes from 880-2), a robot can stop a hall call button push procedure 880-4. Such an action can include a robot ceasing to attempt to activate a hall call button. Hall call button push procedures can include any of those shown herein, including FIGS. 2A to 2C, 7A and FIG. 8A. As the hall call button procedure is stopped, the robot can attempt to board the elevator car corresponding to the open door 880-6. If the robot cannot board the elevator car (Fail from 880-6), the robot can execute a hall call button push operation as described herein or equivalents. A robot may fail to board an elevator car by arriving too late, or by observing predetermined interaction procedures (sensing people and allowing them to board first).

Referring still to FIG. 8A, a hall call push button operation 880-8 according to an embodiment is shown in a flow diagram. A robot can navigate to an elevator watch pose 888-10. Such an action can include a robot navigating to a monitoring position that enables the robot to sense the status of all, or a predetermined number of elevator doors. A robot can determine if a hall call button has already been pressed 880-12. Such an action can include any suitable sensors or communication functions. As but one example, a robot may use an optical sensor to determine whether a hall call button is illuminated. As another example, a robot may communicate with an elevator control system and be notified the hall call button is activated.

If the hall call button is not pressed (No from 880-12), a robot can navigate to a button press position 880-14. Such an action can include any of those described herein. A button press position can be a position close enough to the hall call button to enable the robot to physically activate the hall call button with an extending member. Once in a button press position 880-14 a robot can press the hall call button 880-16. In some embodiments, such an action can include a robot extending a rising member that moves only in a vertical direction, and then pressing the button with a pusher member that extends in only one direction from the rising member. If the hall call button is determined to be activated (Success from 880-16), a robot can return to an elevator watch pose 880-10. If the hall call button is determined not to be activated (Fail 880-16), a robot can attempt the operation again, by repositioning itself (returning to the button press position 880-14).

If the robot is at the elevator watch pose (880-10) and determines that the hall call button has been activated (Yes from 880-12), the robot can wait at the elevator watch pose (880-17). After a predetermined wait period (about two minutes in some embodiments), a robot can return to a watch pose 880-10. Such an action can include the robot repositioning itself, refreshing sensors, or even changing pose (turning from monitoring elevator cars on one side of a hall to monitoring elevator cars on the opposite side of the hall).

FIG. 8B shows a second portion 880-B of a method 880 in which a robot can exit an elevator car. Second portion 880-B assumes that the robot has entered the elevator (i.e., Success, 880-18).

Getting off the elevator 880-B can include a robot determining if an elevator car door has opened at the desired floor 880-20. If the door opens at the desired floor, (Yes from 880-20), a robot can stop a car call button push procedure 880-22. Such an action can include a robot ceasing to attempt to activate a car call button. A car call button push procedures can include any of those shown herein, including FIGS. 2A to 2C, 7A and FIG. 8B. With the car call button procedure stopped, the robot can attempt to exit the elevator 880-24. A robot can determine if it is at a desired floor according to any suitable method, including but not limited to: using sensors (e.g., an optical sensor) to monitor a floor indicator, or elevator car call buttons; using sensors to determine an altitude (e.g., barometric sensors or accelerometers); receiving communications from an elevator system indicating the current floor, or next floor, etc. If a door opens, but it is not at the desired floor (No from 880-20), a robot can continue to determine if the door opens on the desired floor (880-20).

If a robot exits the elevator at the desired floor (Success from 880-24), a robot can continue to navigate to its destination 880-28. If a robot cannot exit the elevator at a desired floor (Fail from 880-24), a robot can start a car call procedure 880-26.

Referring still to FIG. 8B, a car call push button operation 880-26 according to an embodiment is shown in a flow diagram. A robot can navigate to an inside elevator watch pose 888-30. Such an action can include a robot navigating to a monitoring position within an elevator car that enables the robot to sense the status of the elevator car doors. In some embodiments, this can also include the robot being in a position to monitor indicators of elevator position, including but not limited to, a floor indicator and/or the elevator car call buttons. A robot can determine if a car call button has already been pressed 880-32. Such an action can include determining if the car call button for its desired floor has been pressed. This can include any suitable sensors or communication functions as described herein or equivalents.

If the car call button for the desired floor is not pressed (No from 880-32), a robot can navigate to a button press position 880-34. Such an action can include any of those described herein. A button press position can be a position close enough to the car call button to enable the robot to physically activate the car call button with an extending member. Once in a button press position 880-34 a robot can press the car call button 880-36. In some embodiments, such an action can include a robot extending a rising member that moves only in a vertical direction, and then pressing the button with a pusher member that extends in only one direction from the rising member. If the car call button is determined to be activated (Success from 880-36), a robot can return to an inside elevator watch pose 880-30. If the car call button is determined not to be activated (Fail 880-36), a robot can attempt the operation again, by repositioning itself (returning to the button press position 880-34). If the robot is at the inside elevator watch pose (880-30) and determines that the car call button has been activated (Yes from 880-32), the robot can wait at the elevator watch pose (880-38). After a predetermined wait period (about two minutes in some embodiments), a robot can return to a watch pose 880-30.

It should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

It is also understood that other embodiments of this invention may be practiced in the absence of an element/step not specifically disclosed herein.

What is claimed is:

1. A robotic device, comprising:
an enclosure that is longer in a vertical direction than a horizontal direction;
a rising member that includes
at least one pushing member configured to extend and retract in at least one direction with respect to the rising member,
at least one camera configured to image a field of view that includes the at least one direction of the pushing member;
a rising member driver configured to extend and retract the rising member in a vertical direction with respect to the enclosure;
a movement system configured to provide rotational and linear movement for the robot; and
a control system configured to
autonomously navigate to an elevator car location,
identify an elevator call button,
move the robot proximate to the call button,
control the driver to raise the rising member until the pushing member is at a same vertical height as the call button,
rotate the robot to align the pushing member with the call button, and
extend the pushing member to contact and activate the call button.

2. The robotic device of claim 1, wherein:
the rising member has an elongated shape that is substantially wider in a first direction than a second direction when viewed in cross section perpendicular to the vertical direction,
a first pushing member configured to extend in a first direction,
a first camera configured to image a field of view that includes the first direction,
a second pushing member configured to extend in a second direction different than the first direction, and
a second camera configured to image a field of view that includes the second direction.

3. The robotic device of claim 2, wherein the second direction is about 180 degrees from the first direction.

4. The robotic device of claim 1, wherein the at least one pushing member extends and retracts in a direction perpendicular to the vertical direction.

5. The robotic device of claim 1, further including:
the control system is further configured to maneuver the robot to a car monitoring position after activating the call button, and
a beam detection system configured to determine an arrival of any of a plurality of elevator cars from the car monitoring position.

6. The robotic device of claim 5, wherein:
the beam detection system monitors detectable elevator cars while moving the to the car monitoring position.

7. The robotic device of claim 6, wherein:
the beam detection system is configured to detect an opening of elevator car doors and is selected from any of: LIDAR, SONAR, RADAR, optical image processing, and audio processing.

8. A method, comprising:
by operation of a control system for a robot, autonomously navigating to an elevator car location;
by operation of at least one sensor on the robot, identifying an elevator call button;
by operation of a movement system of the robot, positioning the robot proximate to the call button;
extending a rising member vertically from the robot;
rotating the robot to align a pushing member with the call button; and
using sensor information from the robot, extending the pushing member from the rising member to contact and activate the call button.

9. The method of claim 8, wherein:
extending the pushing member from the rising member to contact and activate the call button,
locating the call button with at least one camera mounted on the vertical member, the at least one camera having a field of view that includes a movement path of the pushing member.

10. The method of claim 8, wherein the at least one pushing member extends and retracts in a direction perpendicular to the vertical direction.

11. The method of claim 8, further including:
by operation of the control system of the robot, maneuvering the robot to a car monitoring position after activating the call button.

12. The method of claim 11, further including:
by operation of a beam detection system of the robot, determining an arrival of any of a plurality of elevator cars from the car monitoring position.

13. The robotic device of claim 12, wherein:
the beam detection system monitors detectable elevator cars while moving the to the car monitoring position.

14. The robotic device of claim 12, wherein:
the beam detection system is configured to detect an opening of elevator car doors and is selected from any of: LIDAR, SONAR, RADAR, optical image processing, and audio processing.

15. A method, comprising:
by operation of a control system of a robot, navigating to an elevator door monitoring position;
by operation of at least one sensor on a robot, determining if an elevator door has opened;
attempt to board an elevator; and
if the robot fails to board the elevator, execute a hall call button pushing operation that includes
navigate to an elevator button pushing position,
vertically extend a rising member, and
extending a pushing member from the rising member to push the elevator button.

16. The method of claim 15, further including:
by operation of at least one sensor on the robot, determining if the hall call button has been pushed prior to executing the hall call button pushing operation.

17. The method of claim 16, further including:
if the hall call button has been determined to have been pushed, navigating to an elevator watch position where sensors of the robot can determine if at least one elevator door opens.

18. The method of claim 15, wherein:
by operation of at least one sensor on the robot, determining if an elevator car has arrived at the desired floor.

19. The method of claim 15, wherein:
if the robot fails to exit the elevator car at a desired floor, execute a car call button pushing operation that includes
navigate to an elevator car call button pushing position,
vertically extend the rising member, and
extending the pushing member from the rising member to push the elevator car call button.

20. The method of claim 15, further including:
by operation of at least one sensor on the robot, determining if the elevator car call button has been pushed prior to executing the car call button pushing operation; and
if the elevator car call button has been determined to have been pushed, navigating to an elevator car door position where sensors of the robot can determine if an elevator door of the elevator car opens.
